(19) United States
(12) Patent Application Publication
(10) Pub. No.: US 2020/0071071 A1
(43) Pub. Date: Mar. 5, 2020

(54) TEMPORARY BULKHEAD FOR SHIPPING CONTAINER

(71) Applicant: BASELINX LLC, Penfield, NY (US)

(72) Inventor: Michael Ross Joyce, Penfield, NY (US)

(73) Assignee: BASELINX LLC, Penfield, NY (US)

(21) Appl. No.: 16/531,933

(22) Filed: Aug. 5, 2019

Related U.S. Application Data
(60) Provisional application No. 62/714,257, filed on Aug. 3, 2018.
(60) Provisional application No. 62/742,031, filed on Oct. 5, 2018.

(51) Int. Cl. B65D 90/00; B60P 7/14

(52) U.S. Cl. CPC B65D 90/0066; B60P 7/14

(57) ABSTRACT

A double door temporary bulkhead locking member comprising a single or joined rigid material with the angle apex pointing inward. The temporary bulkhead is wedged across the width of the inside opening of a container. When the flowable product is installed into the container the pressure on the bulkhead is transferred to the outer edges sealing the product into the container. The temporary bulkhead material has a series of creases, notches, slots and shapes that are folded and locked into the proprietary shape. A single door bulkhead locking member comprising a single or joined rigid material as a straight plain panel to fit into the single doorway of a shipping container. The temporary bulkhead is wedged across the width of the inside opening of a container when one door is closed and the other open. When the flowable product is installed into the container the pressure on the bulkhead is transferred to the outer edges sealing the product into the container. The temporary bulkhead material has a series of creases, notches, slots and shapes that are folded and locked into the proprietary shape.

### BACKGROUND OF THE INVENTION

The present invention relates to temporary bulkheads for shipping containers.

Shipping containers are well known and are typically in the form of a large rectangular box made of strong materials such as, for example, corrugated steel, aluminum, and fiber-reinforced polymers. Access to the container may be provided by double doors which are hinged to one open end of the container. These types of shipping containers are used to ship all types of durable goods by all modes of transportation including truck, air, rail and ship. The containers are mostly identical in form so that they are easily stackable.

Solid form goods are easily loaded into and out of the shipping container through the double door access. Goods which exhibit fluidic characteristics when in bulk form (e.g., free flowing bulk grains, formed pellets as seen in certain animal feeds, loose flowing soils, minerals, ores and other substances of like flowable character) are also shipped in these containers but the loading and unloading process is a bit more difficult. As the flowable product is deposited into the container, something must be placed at the point of entry to prevent the material from flowing outside the container, particularly if the container is to be filled to capacity.

Temporary bulkheads for shipping containers have been proposed and may be seen in AU2007201346A1, for example.

### SUMMARY OF THE INVENTION

In a first embodiment, the present invention provides a double door temporary bulkhead locking member comprising a single or joined rigid material with the angle apex pointing inward. The temporary bulkhead is wedged across the width of the inside opening of a container. When the flowable product is installed into the container the pressure on the Bulkhead is transferred to the outer edges sealing the product into the container.

The temporary bulkhead material has a series of creases, notches, slots and shapes that are folded and locked into the proprietary shape.

A Single Door bulkhead locking member comprising a single or joined rigid material as a straight plain panel to fit into the single doorway of a shipping container. The temporary bulkhead is wedged across the width of the inside opening of a container when one door is closed and the other open. When the flowable product is installed into the container the pressure on the Bulkhead is transferred to the outer edges sealing the product into the container.

The temporary bulkhead material has a series of creases, notches, slots and shapes that are folded and locked into the proprietary shape.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1A is a perspective view of the installed temporary bulkhead invention wedged into the open container in the intended manner with both hinged container doors open.

FIG. 1B is a top view showing the installed position of the temporary bulkhead invention of FIG. 1A in the sides of the shipping container.

FIG. 2A is the top view of the temporary bulkhead as if it was installed.

FIG. 2B is the front view of the temporary bulkhead before it is wedged into the container.

FIG. 2C is the side/end view of the temporary bulkhead profile.

FIG. 3A is the cutout/creased outline of the temporary bulkhead material.

FIG. 3B is the extra support/hold-down flaps that are attached to the bottom of the inside panel where the flowable product is placed against the temporary bulkhead. (see FIG. 2C).

FIG. 4 is a perspective drawing of the circled section on FIG. 2B.

FIG. 5A is a perspective view of the installed temporary bulkhead invention wedged into the single open doorway of the container in the intended manner with one hinged container doors closed and the other open.

FIG. 5B is a top view showing the installed position of the temporary bulkhead invention of FIG. 5A in the single open doorway of the shipping container.

FIG. 6A is the top view of the single door temporary bulkhead.

FIG. 6B is the front view of the temporary bulkhead before it is wedged into the container.

FIG. 6C is the side/end view of the temporary bulkhead before it is wedged into the container.

FIG. 7A is a perspective view of the installed temporary bulkhead invention wedged into the open container in the intended manner with both hinged container doors open.

FIG. 7B is a top view showing the installed position of the temporary bulkhead invention of FIG. 7A in the sides of the shipping container.

FIG. 8A is the top view of the temporary bulkhead in an installed position.

FIG. 8B is the front view of the temporary bulkhead before it is wedged into the container opening.

FIG. 8C is the side/end view of the temporary bulkhead profile.

FIG. 9A is the cutout/creased outline of the temporary bulkhead sheet material prior to assembly and installation in a container opening.

FIG. 9B is a top view of the assembled temporary bulkhead.

FIG. 10 is a perspective drawing including the circled section of FIG. 8B.

FIG. 11A is a perspective view of the installed temporary bulkhead invention wedged into the single open doorway of the container in the intended manner with one hinged container doors closed and the other open.

FIG. 11B is a top view showing the installed position of the temporary bulkhead invention of FIG. 11A in the single open doorway of the shipping container.

FIG. 12A is the top view of the single door temporary bulkhead.

FIG. 12B is the front view of the temporary bulkhead before it is wedged into the container.

FIG. 12C is the side/end view of the temporary bulkhead before it is wedged into the container.

FIG. 13A is a fragmented perspective view of a temporary bulkhead panel showing the locking tab for the upper support.

FIG. 13B is an elevational view showing the locking tab extending though the panel.

FIG. 14 is a front perspective view of two temporary bulkhead panels stacked one on the other.

FIG. 15 is a front perspective view showing two stacked temporary bulkhead panels positioned in the opening of a storage frame in the intended manner.

### DETAILED DESCRIPTION OF PREFERRED EMBODIMENTS

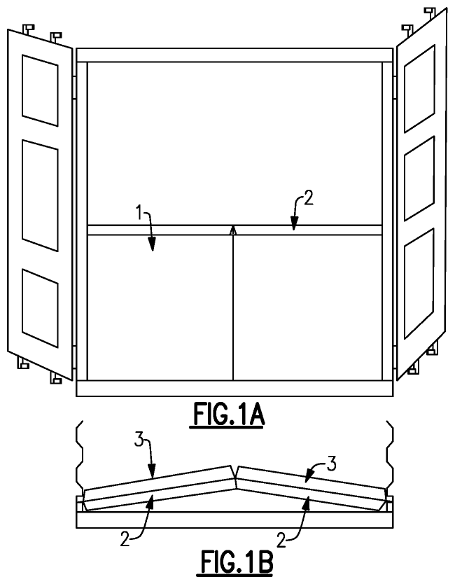

FIG. 1A-1 is the main upright rigid material of the temporary bulkhead made to various heights for the given flowable product.

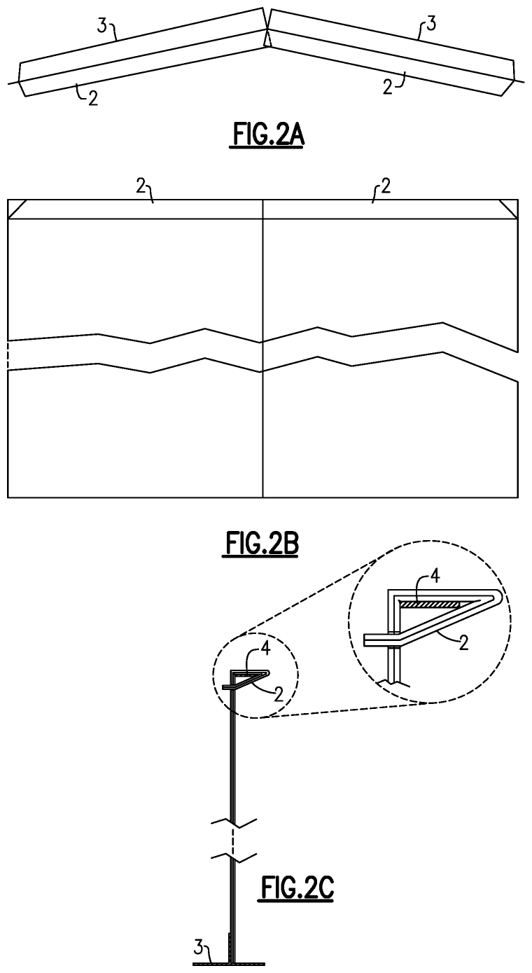

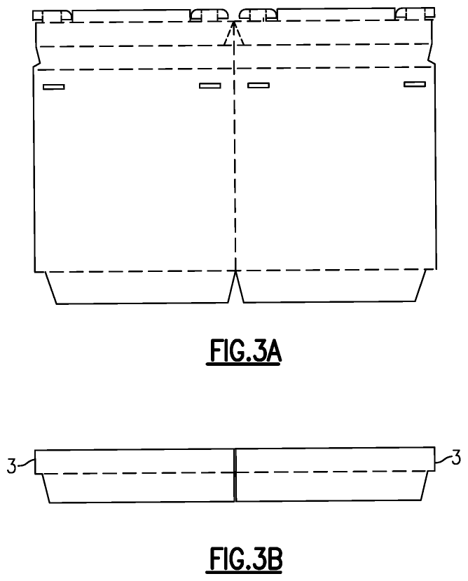

Reference number 2 is the creased and folded profile of the top of the temporary bulkhead as seen in FIGS. 1B, 2A, 2B, and 2C.

FIG. 1B reference number 3 is the bottom extra support/hold-down flaps that are attached to the bottom of the inside panel where the flowable product is placed against the temporary bulkhead. (see FIG. 2C).

FIG. 2C and enlarged call-out drawing is the strengthening section substrate 4 used where added strength is required. These are located is each folded section on both sides of the center vertical crease.

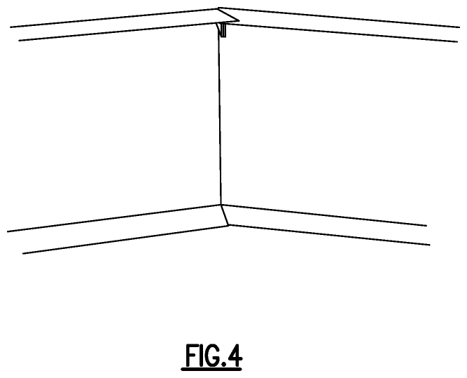

FIG. 4 is a perspective drawing of the circled section on FIG. 2B. The design here is such that the angled creases fold down and when the temporary bulkhead is collapsed/folded into the container opening they act as buffer stoppers to stop the temporary bulkhead from folding any further, thus locking/holding the bulkhead in place in the container.

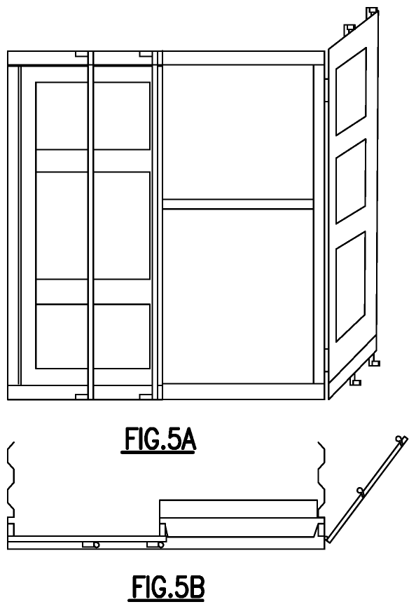

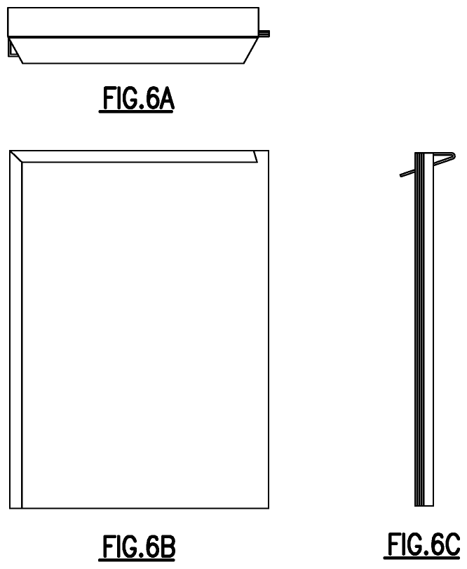

FIG. 5A is a perspective view of the installed temporary bulkhead invention wedged into the single open doorway of the container in the intended manner with one hinged container doors closed and the other open.

FIG. 5B is a top view showing the installed position of the temporary bulkhead invention of FIG. 5A in the single open doorway of the shipping container.

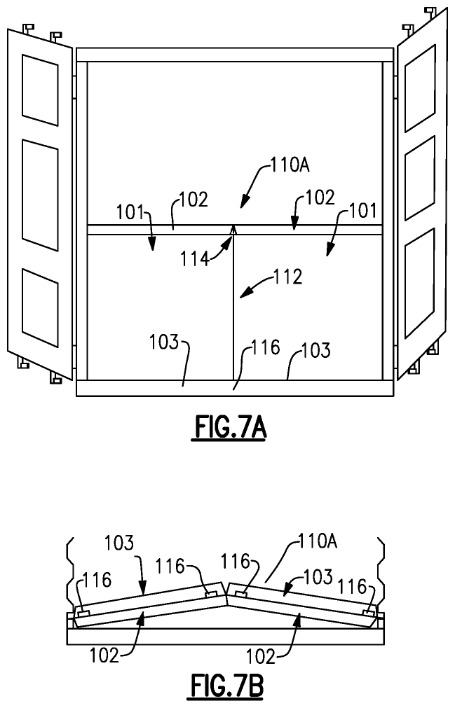

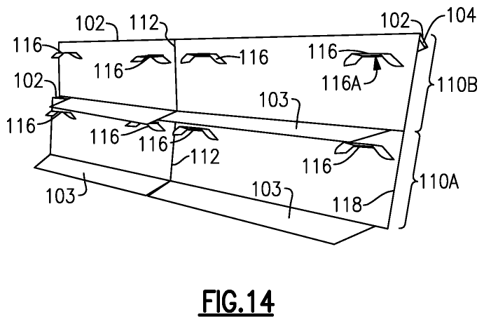

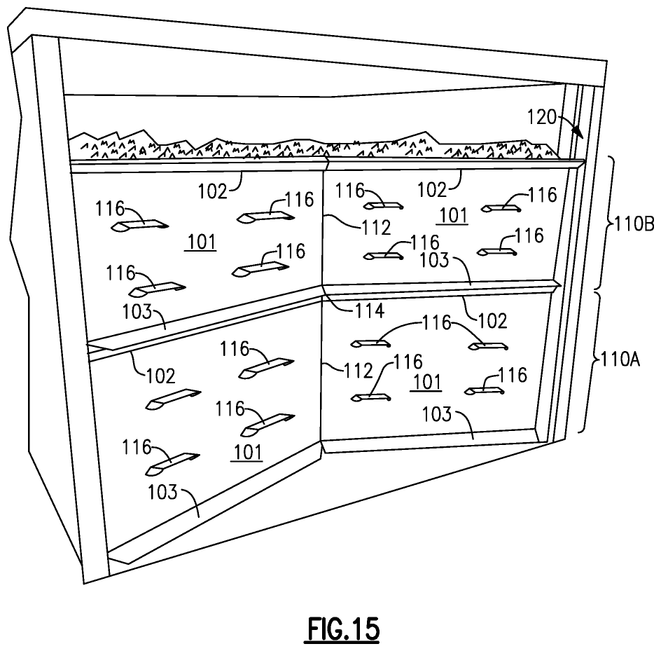

Attention is turned to further preferred embodiments. A single temporary bulkhead 110A is seen in FIG. 7A and is the main upright rigid material for removably securing in a double door container opening and may be made to various heights for the given flowable product. Two identical temporary bulkheads 110A and 110B are seen in FIGS. 14 and 15 with bulkhead 110B stacked upon bulkhead 110A. Any number of bulkheads may be stacked in this manner to achieve the desired height in the container opening.

Reference numeral 102 shows the creased and folded profile of the top of the temporary bulkhead.

Reference numeral 103 is the bottom extra support/hold-down flaps that are attached to the bottom of the inside panel 101 where the flowable product is placed against the temporary bulkhead.

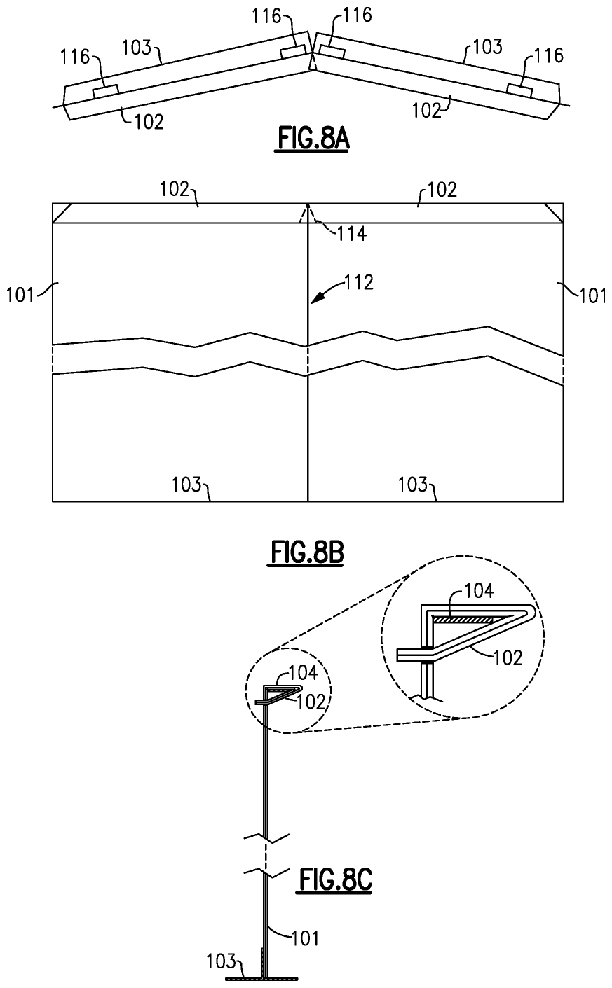

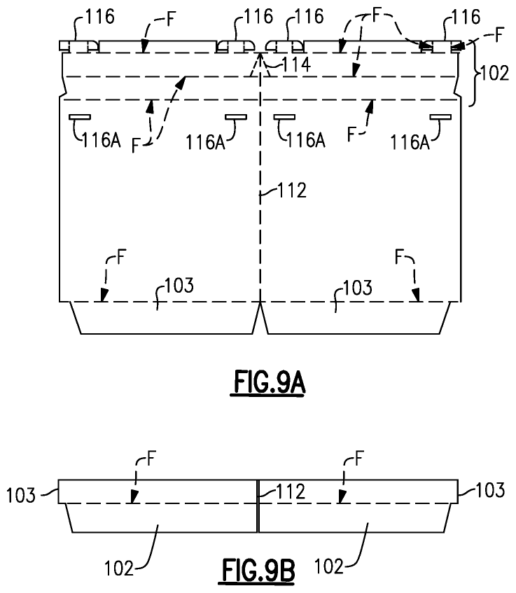

FIG. 8C and enlarged call-out drawing shows the strengthening section substrate 104 used where added strength is required. Rigid rectangular, elongated panels 104 may be inserted into each folded section 102 on both sides of the center vertical crease 112.

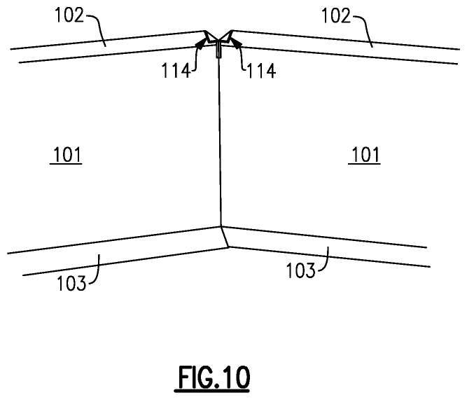

FIG. 10 best shows the angled creases fold down 114 and when the temporary bulkhead is collapsed/folded into the container opening they act as buffer stoppers to stop the temporary bulkhead from folding any further, thus locking/holding the bulkhead in place in the container.

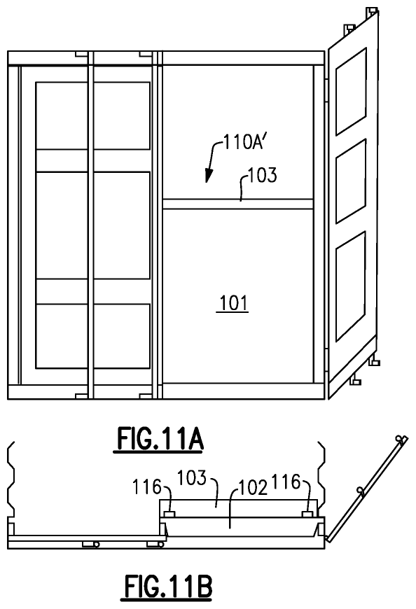

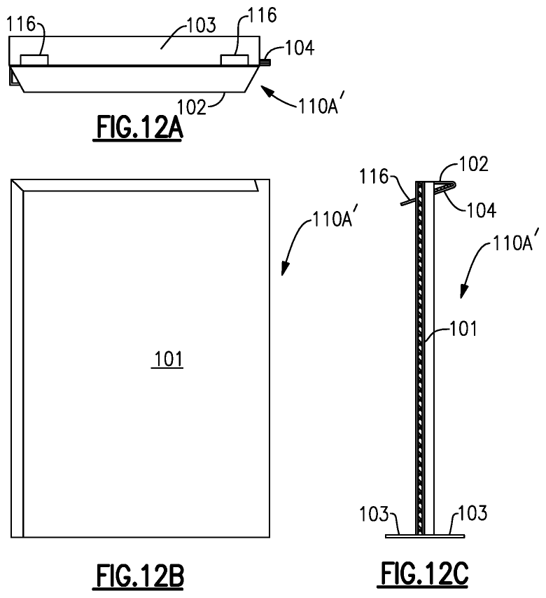

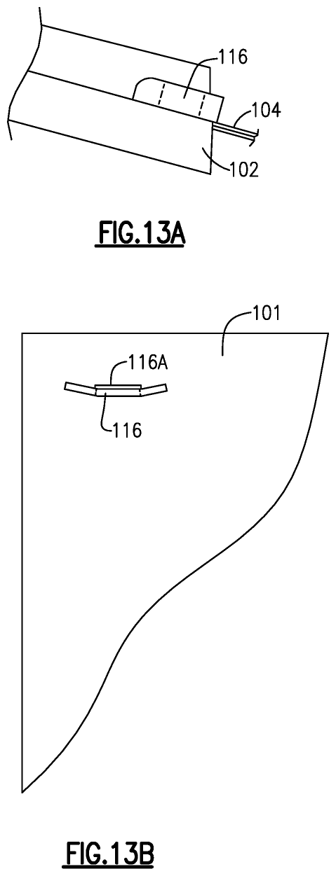

FIG. 11A is a perspective view of a version 110A′ of the installed temporary bulkhead invention (110A′ is essentially one half of a double bulkhead 110A—with no need for center crease 112) wedged into the single open doorway of the container in the intended manner with one hinged container doors closed and the other open.

FIG. 11B is a top view showing the installed position of the temporary bulkhead invention of FIG. 11A in the single open doorway of the shipping container.

A list of all parts follows:

Ref no. 101—bulkhead panel wall.

Ref no. 102—folded strengthening section at top of panel 101.

Ref no. 103—folded flap at bottom of panel 101.

Ref no. 104—optional, rigid strengthening board for removable insertion into opening created by folded strengthening section 102—board 104 may extend entire length of strengthening element 102, if desired.

Ref nos. 110A and 110B—identical temporary bulkheads for positioning in double door opening.

Ref no. 110A′—alternate embodiment of temporary bulkhead for single door opening.

Ref no. 112—center vertical crease line in temporary bulkhead 110A, 110B.

Ref no. 114—overlap of divided sections 102 at crease line 112 when temporary bulkhead 110A, 110B is in angled (about crease line 112), installed position.

Ref no. 116—foldable securing tab for securing strengthen section 102 which may form a triangular shape in cross section.

Ref no. 116a—open slot in panel 101 for passage of securing tab 116 which may then be folded at fold lines “F” to prevent unintentional withdrawal of tabs 116 from slots 116a.

Ref no. 118—opposite side edges of bulkhead panel 101 for removably securing bulkhead into vertical slot of shipping container side walls.

Ref no. 120—same as 118 except for frame opening.

It will be appreciated the bulkheads 110A, 110B, 110A′ may be packaged flat and assembled on site for compact packaging and ease of installation.

The dimensions of the bulkheads 110A, 110B and 110A′ may be selected according to the respective dimensions of the container or frame opening where they are to be installed.

A Double Door Embodiment may have one or more of the following in any combination:

1. A Temporary Bulkhead for a shipping container that collapses/folds into the opening of a container and locks into position through the designed shape of the material it is made from providing holding support to hold/lock the temporary bulkhead in place. This is achieved through notching creasing, folding and shape and rigidity of material.

2. The rigid inserts that are folded into the Temporary Bulkhead for a shipping container to provide extra strength when needed in the top folded section.

3. The use of layers of corrugated material laminated to provide greater rigidity for heavier flowable products.

4. The use of the triangle stiffening design at the top of the temporary bulkhead.

5. The double inward facing and outward facing angled flaps at the bottom of the temporary bulkhead.

6. The design is stackable due to the modular design to gain greater height to maximize capacity.

A Single Door Embodiment may have one or more of the following in any combination:

1. The single door design has the same profiles and use of laminated product as the double door.

2. The single door has a unique side section that acts as a spacer to allow the second door to close without destroying the top and bottom folded sections.

3. The design is stackable due to the modular design to gain greater height to maximize capacity.

4. The rigid inserts that are folded into the Temporary Bulkhead for a shipping container to provide extra strength when needed in the top folded section.

5. The use of the triangle stiffening design at the top of the temporary bulkhead.

While this method and apparatus has been shown and described with reference to certain preferred embodiments thereof, it will be understood by those skilled in the art that various changes in form and details may be made therein without departing from the spirit and scope of the invention as described.

What is claimed is:

1. A temporary bulkhead for a shipping container that collapses/folds into the opening of a container and locks into position through the designed shape of the material it is made from providing holding support to hold/lock the temporary bulkhead in place achieved through notching creasing, folding and shape and rigidity of material.

2. The temporary bulkhead of claim 1 and further comprising rigid inserts that are folded into the temporary bulkhead for a shipping container to provide extra strength when needed in the top folded section.

3. The temporary bulkhead of claim 1 and further comprising the use of layers of corrugated material laminated to provide greater rigidity for heavier flowable products.

4. The temporary bulkhead of claim 1 and further comprising use of the triangle stiffening design at the top of the temporary bulkhead.

5. The temporary bulkhead of claim 1 and further comprising double inward facing and outward facing angled flaps at the bottom of the temporary bulkhead.

6. The temporary bulkhead of claim 1 wherein the temporary bulkhead is stackable due to the modular design to gain greater height to maximize capacity.

7. The temporary bulkhead of claim 1 wherein the single door design has the same profiles and use of laminated product as the double door.

8. The temporary bulkhead of claim 7 wherein the single door has a unique side section that acts as a spacer to allow the second door to close without destroying the top and bottom folded sections.

9. The temporary bulkhead of claim 8 wherein the design is stackable due to the modular design to gain greater height to maximize capacity.

10. The temporary bulkhead of claim 9 wherein the rigid inserts that are folded into the Temporary Bulkhead for a shipping container to provide extra strength when needed in the top folded section.

11. The temporary bulkhead of claim 10 wherein the use of the triangle stiffening design at the top of the temporary bulkhead.
